(19) United States
(12) Patent Application Publication
(10) Pub. No.: US 2011/0070382 A1
(43) Pub. Date: Mar. 24, 2011

(54) Novel lens-protecting processing films

(76) Inventors: Agustin Alberto de Rojas, Boca Raton, FL (US); Martin Lenard Hage, Maple Grove, MN (US); Andrew Brian de Rojas, Delray Beach, FL (US)

(21) Appl. No.: 12/586,617

(22) Filed: Sep. 23, 2009

(51) Int. Cl. B06B 1/20; B05D 3/12; B05D 3/00

(52) U.S. Cl. 427/600; 427/154; 427/155

(57) ABSTRACT

A method is performed for temporarily protecting lenses before subsequent treatment of the lens. The process provides a polymeric ophthalmic lens having a front surface and a rear surface, then provides a coating solution comprising a water-soluble/dispersible or organic-soluble/dispersible organic polymer in a solvent, the solvent not attacking or dissolving the polymeric ophthalmic lens. A coating solution is applied to at least one of the front surface or the rear surface. The coating solution is dried on the lens to form a temporary protective coating. The lens is supported. The lens is modified. The dried coating is then dissolved/dispersed the dried coating in a second solution without attacking, dissolving or damaging the lens.

### BACKGROUND OF THE INVENTION

1. Field of the Invention

The present invention relates to lenses, particularly to polymeric ophthalmic lenses, more particularly to a method for protecting polymeric ophthalmic lenses and securing polymeric ophthalmic lenses to the processing equipment that are used for surfacing and/or edging such lenses. After the lens has been surfaced, polished, and edged, the protective film can be removed by washing and/or rinsing with a solvent to which the lens is inert, such as aqueous or alcoholic solutions.

2. Background of the Art

Ophthalmic and other lenses are commonly manufactured from polymeric materials, which have numerous advantages over glass, including less weight and greater safety due to reduced risk of breakage.

Some manufacturing processes require that during processing the lens should be protected from incidental contact with various materials and surfaces that could possibly damage the lens. A further requirement is that the lens is firmly secured in a very precise location while the lens is acted upon by various processing equipment.

This processing equipment includes the equipment that is used to grind or surface at least the back surface of the lens so as to achieve the desired power or prescription. This same or other equipment is used to polish the lens to impart maximum clarity, eliminating the haze or scattered light that results from the surface imperfections, roughness or scratches due to grinding. The processing equipment also includes edgers that are used to impart the correct, precise geometry to the perimeter of the lens, such that it will correctly fit into the wearer's frame or some other device in the event that it is not a spectacle lens.

The current state of the art for the surfacing and polishing processes is to employ a tape, a polymeric film with an adhesive on one side, to protect the lens. The tape is firmly pressed to the front side or base curve of the lens, after which the excess tape is cut away from around the perimeter of the lens. A metal alloy or a wax is then used as an adhesive to block, bond or secure, the chuck of the equipment to the tape that has been applied to the front of the lens. After the surfacing and polishing has been completed, the tape is removed by manually peeling it off of the lens.

The current state of the art for the edging process includes applying a round, elastomeric, adhesive pad to the front side of the lens. Any tape that had been applied prior to surfacing and polishing may optionally be left in place. These adhesive pads have adhesive on both sides, much like a double-sided adhesive tape. The adhesive pad is firmly pressed to the front side of the lens. The lens can then be secured to the chuck of the equipment. Following edging, the adhesive pad is manually removed by peeling the pad itself off of the lens or, in the case where the protective tape was left on the lens, by peeling the protective tape off of the lens.

However, the use of tape and adhesive pads in the current state of the art has several shortcomings, which include at least the following.

The use of tape has the inherent risk of leaving an adhesive residue, which residue can result in defects after subsequent processing. For example, it is often desirable to apply an antireflective coating after a lens has been surfaced and any residue could interfere with application of any subsequent coating or tinting operation. In addition to creating particle defects, any adhesive residue is not likely to be entirely removed by the cleaning processes that are commonly employed prior to the application of an antireflective coating, in which case the antireflective coating can be defective. The use of the current invention leaves no residue or at least less residue that might not be removed by subsequent cleaning processes that are commonly employed in the art. It should also be noted that the adhesives that are used in the manufacture of the tapes of the current state of the art are colorless, thus they provide no indication as to their presence. The compositions of the current invention preferably have a fluorescent dye or other colorant such that any unremoved residue would immediately be apparent.

Also, the adhesive pads and, to some degree, the tapes that are used for blocking purposes, are opaque, thus not allowing the user to see progressive markings or other indicia that are commonly printed on the front surface of the lenses, which markings are essential for the proper alignment of the lens in the surfacing equipment.

Moreover, the removal of the tapes and the adhesive pads often removes these markings, despite the fact that these markings are often needed for subsequent processing steps. The use of the current invention allows for the removal of the protective, adherent film, without the removal of the markings that are needed for proper alignment of the lens in the processing equipment.

In addition, the tapes and adhesive pads have an elastomeric adhesive layer that is relatively thick and deformable, which can result in a loss of precision in processing. This problem can be eliminated with the use of the current invention, which provides for highly adherent films that are much thinner, less than one tenth the thickness of the adhesives of the current art, and relatively non-deformable (non-compressible), under the pressures that are typically employed in the processing equipment.

Furthermore, many of the tapes and adhesive pads of the current state of the art do not provide adequate adhesion to some of the many different types of final coating or pre-coatings that are used on the front surface. Inadequate adhesion results in the lens slipping during the surfacing or edging processes, such that the resulting lens shape and, therefore, lens power may be incorrect, which in turn results in waste, since there is usually no way to recover a damaged lens. The problem of slippage presently occurs in roughly 20 to 40 percent of all lenses, but is most common with lenses having a super-hydrophobic coating, to which adhesion is very difficult to obtain. Although all slippage does not result in loss of the lens, there may be lenses that are allowed into commerce with marginal properties caused by modest slippage. Many of these coatings on the lenses before application of prior art tapes and pads have very low surface energies and, therefore, have water contact angles of greater than 100 degrees. Because the adhesive of the surfacing tape is a thermoplastic elastomer, the problem of poor adhesion can be exacerbated if the coolant temperature is relatively warm during surfacing and polishing. In some cases, the cutting rate or the feed rate, the rate at which the lens is moved into the cutting tool of the surfacing or edging equipment, can be reduced to help prevent the problem of slippage, but this is undesirable due to the loss of production that would result. In some instances, a special adhesive pad is used during the edging process, but often with little or no benefit, in spite of the added expense. The common levels of problems of slippage during the surfacing and edging processes may be substantially or effectively completely eliminated with the use of the current invention.

Lastly, another problem often arises due to the use of tape in the surfacing of multifocal lenses, particularly trifocals, more particularly bifocals, and most particularly bifocals of high add powers. It is extremely difficult for the tape to conform well to all surfaces around the segment line(s) where the add portion meets the base curve of the lens. In this area of the lens, there is commonly a bubble of air between the adhesive and the front surface of the lens. This bubble of air acts as a cushion, preventing uniform pressure from being applied to the lens, particularly a thinner lens, as it is being cut and polished, which in turn results in an aberration in the lens. Through the use of the current invention, this problem can be reduced or effectively avoided entirely, since the films of the current invention conform nearly perfectly to the entire front surface of the lens, thereby allowing uniform pressure to be transmitted to the back side of the lens, which is being pressed against the tool as it is being cut and polished during the surfacing process.

The use of the compositions and processes of the current invention can reasonably reduce or eliminate most or all of the aforementioned problems. Previous methods known in the art neither address nor are applicable to these problems.

U.S. Pat. Nos. 3,899,315 and 3,899,314 relate to the texture control of glass ophthalmic lenses by use of a protective layer, which is removed prior to use. A flat glass lens preform is provided with a thin protective layer of a chemically soluble glass fused thereto. In the manufacturing process, the flat preform is subsequently cut and pressed or slumped to the desired ophthalmic shape and the protective layer subsequently removed by dissolving this in a corrosive reagent, thereby exposing the underlying surface which, while smooth, nevertheless needs to be cleaned. The lens is rendered immediately adaptable to ophthalmic use, without further working, such as grinding, polishing or cleaning, of the surface. However, this wet process is not suitable for reagent sensitive plastic lenses.

U.S. Pat. No. 6,761,784 teaches the use of coatings for the temporary protection and cleaning of optical elements that are subsequently laminated to make a finished lens. Nowhere in the manufacture of such lenses are the lenses ever surfaced to create the desired prescription, which is obtained by the use of a radiation curable adhesive to bond two optical elements together. Furthermore, the processes of the said patent require that the coating be removed prior to completing the lamination process to form the lens, and that of necessity, whereas the films of the current invention are intended to be present during the edging process for the benefit that they provide. Also, it is stated in the above patent that the strength of the adherence of the protective film to the polymeric optical element is also of only modest importance, thus the compositions that are disclosed in the above patent have inadequate adhesion to the mar resistant, antireflective and other coatings that are present on ophthalmic lens blanks, such that they are unsuitable for the purposes of securing lenses to the chucks of the surfacing as well as the edging equipment that are commonly employed by those that are skilled in the art. Finally, the compositions claimed by the aforementioned patent require the use of polymers having an acid value of greater than or equal to 100, such that removal by aqueous solutions will be facile as desired. The films of the present invention utilize polymers having acid values considerably less than 100 since removal by water alone is not desired as this would result in the lens coming off of the chuck during the surfacing process, which process employs an aqueous solution to cool the lens, remove debris created in the process, and perform other functions during the process.

### SUMMARY OF THE INVENTION

The protection and processing of polymeric lenses, particularly ophthalmic lenses, can be efficiently effected by the use of the compositions of the present invention, the compositions being applied as a liquid coating to the front surface of the lens. The coating is then dried under ambient conditions or the drying may be accelerated with the use of heat or radiation to produce heat (e.g., infrared and visible radiation, ultraviolet radiation or combinations thereof, but not to crosslink the polymer, just to accelerate drying) to form a durable film having excellent adhesion. Following the surfacing and/or edging processes, the film of the present invention may be removed by dissolution or dispersion through the use of an appropriate solvent or cleaning solution that will not solvate or attack the lens.

### DETAILED DESCRIPTION OF THE INVENTION

A coating solution of the current invention is prepared by dissolving from about 10 to about 40 weight percent of a polymeric material in from about 90 to about 60 weight percent of one or more suitable solvents. A suitable solvent is put into a mixing vessel after which is added to the same mixing vessel a suitable polymeric material. A suitable solvent is one that will completely dissolve the thermoplastic polymer but will not dissolve, disperse, attack, or otherwise affect the lenses or the coatings that are on the lenses to which the coating of the present invention is to be applied. A suitable polymeric material is one that is a tack free solid when in neat form and is thermodynamically stable such that it will not decompose or polymerize when in sealed containers, when exposed to aqueous solutions, when exposed to temperatures up to 250° F., or when exposed to the air. Suitable polymers include, but are not limited to acrylics, polyurethanes, polyesters, and other thermoplastic polymeric materials that can be dissolved or dispersed in a suitable solvent as described above. One such example of a suitable polymer is Joncryl® 611 polymer (acrylic polymer, acrylic acid or acrylic acid-styrene polymer) from BASF. The polymer, at the time that it is added to the mixing vessel, may be in either neat or solution form. In the case of the latter, it would have been previously dissolved in a solvent by the manufacturer. Optionally, a surfactant, preferably a fluorosurfactant of low surface tension, such as Masurf® 2000 from Mason Chemical or FC-4430 from 3M, is added to facilitate the wetting of the coating solution, when it is applied to difficult to wet surfaces, such as super hydrophobic coatings. The surfactant will also aid in providing uniform film thickness and coverage over the entire surface of the lens but will also enhance adhesion of the resulting dried protective film to various substrates, particularly super hydrophobic coatings. Furthermore, the surfactant will aid in the original dissolution of the polymer as well as in the removal of the dried film from the lens, for which reason it is preferred that the surfactant be added to the mixing vessel after the solvent has been added but before the polymer is added. Optionally, from about 0.01 to about 1.00 percent by weight of a colorant, such as a pigment or, preferably, a dye, may be added to impart color to the film such that it will be obviously apparent that the coating has been applied, that the entire lens has been coated, that the coating is of uniform thickness, and, after cleaning the lens to remove the film, confirm that the film has been entirely removed. Dyes are preferred since dyes are much more soluble than pigments, thus allowing for greater transparency in the dried film. Preferably, the colorant is added to the mixing vessel after the polymer has been added. The coating solution may be used immediately or stored in sealed containers for more than one year at room temperature prior to use. Optionally, heat, stirring and ultrasonics may be used to facilitate the dissolution of the polymer. If heat is used, it is preferred that a condenser be used so as to minimize or prevent evaporative losses.

A cleaning solution of the current invention for the removal of the temporary protective film of the current invention is prepared from one or more suitable solvents (suitability again being determined by solvent action on the temporary protective film and lack of significant solvency or deleterious effects on the lens during the limited time in which the removal solvent is used in the procedures of the present technology) in which the dried film is soluble, including the solvent from which the original film was deposited. The one or more selected solvents are mixed together and must be mutually soluble in one another to prevent separation over time. Examples of suitable solvents include, but are not limited to, water, 2-propanol, 2-propanone, 1-methoxy-2-propanol, lower molecular weight alcohols, and their glycol ethers. A wide variety of solvents may be used to obtain the right balance of speed of removal, toxicity, flammability, odor, cost, and other considerations. A suitable solvent (as additionally described below) is a solvent that will dissolve the dried film but will not adversely affect the other permanent coatings that are on the lens nor will it affect the lens itself. Some solvents may be suitable for some lens materials but not others. For example, pure acetone will not attack certain thermoset cast lens materials, but will solvate, dissolve, attack, or otherwise damage bisphenol A polycarbonate, so pure 2-propanone would not be suitable for a lens of pure bisphenol A polycarbonate. Furthermore, whereas a particular solvent in pure form might damage a certain lens material, when diluted in another solvent, the combination might not damage the same lens material under the same conditions. For example, 2-propanone is known to rapidly attack bisphenol A polycarbonate but a 1:1 (e.g., 2:1 to 1:2 weight proportions) weight ratio of 2-propanone and water will not harm the same bisphenol A polycarbonate during the limited time frame of exposure needed to remove a temporary film according to the present technology. Optionally, ammonia, sodium hydroxide, potassium hydroxide, or some other base or alkaline materials may be dissolved in the cleaning solution, especially aqueous solutions, to facilitate the removal of the dried film. These may be added in the amount of from about 0.1 to about 10.0 percent by weight. This is advantageous in those instances where the film was prepared from a polymer having an acid value of 25 or greater. The addition of a base is even more effective in the removal of the dried film if the polymer has an acid value of 50 or greater. In such cases, an organic solvent may not be necessary to remove the film, thus the flammability of the cleaning solution can be reduced or altogether eliminated by the avoidance of organic solvents. Although many organic solvents are somewhat flammable, where possible, they have an advantage over water in that they are more volatile, thus their use will provide a faster drying film and thereby allow for shorter process times, which will in turn lead to greater productivity. Similarly, acids may be added to the cleaning solution for the removal of cationic polymers having amino groups. Optionally, a surfactant, whether anionic, nonionic, or cationic, may be added to the cleaning solution in the amount of from about 0.1 to 5.0 percent by weight to aid in the removal, dispersion, and suspension of the dried film. The cleaning solution may be used immediately or stored in sealed containers for more than one year at room temperature.

A general procedure according to the present technology may be described as applying to the front surface of a semifinished lens or lens blank, approximately 2 milliliters of a previously prepared coating solution, as generally described previously, the coating solution being spray applied (it may be otherwise applied by various commercial processes, as the film may be allowed to stabilize to a consistent or desirable thickness before drying) while the lens is spinning at approximately 1,000 rpm. After the coating solution has been applied, the lens may then be spun for an additional time (e.g., approximately 5 seconds) to remove the excess coating from the lens and form a wet film of uniform thickness of approximately 6 microns. Alternatively, the coating solution may be applied by brushing, rolling, printing, or other means followed by spinning to create a highly uniform film thickness so as to avoid defects that would otherwise be created during subsequent processing.

Following the application of the coating, the wet film is dried (preferably, but not required) at room temperature or slightly elevated temperature (e.g., +40°F.) for approximately ten minutes, depending upon the temperature and humidity of the ambient air. During the drying process, the wet film thickness of approximately 6 microns will be reduced to a dry film thickness of approximately 2 microns (e.g., 2-5 microns±0.4 microns). This is typically a lacquer dry, which involves simply the evaporation of the volatile constituents, the coalescence of any micelles or other particles, if any, and film formation. Reactive chemistry such as crosslinking, free radical, anionic, cationic, oxidative, or other cure may be less preferably used but is typically not involved, so that the subsequent removal of the dried film at a later time will be more facile (e.g., less aggressive solvent action may be used). Alternatively, the wet film may be dried with the use of any additional heat, which may be desirable when the ambient air is cold or humid but may also be desirable when less volatile solvents are used due to flammability, odor, or environmental concerns. For example, the lens may be placed inside a forced air oven, that is, an oven having a fan to circulate the air that is inside the oven. Typically, approximately 2 minutes at a temperature of approximately 120° F. is sufficient to dry the wet film. Alternatively, to dry the wet film, a convection oven may be used, that is, an oven that has no fan but has the heat source at the bottom of the oven such that the air that is inside the oven will rise and circulate due to convection. Alternatively, a source of infrared light or radiation, which is also known as radiant heat, may be used to more rapidly dry the wet film.

After the film has dried, the lens may be blocked by securing the chuck of the surfacing equipment to the film that is on the front side of the lens. This may be done using means that are familiar to those skilled in the art of surfacing lenses. Although there are other means of doing this, typically, this involves using a metal alloy having a low melting point as an adhesive to temporarily secure the chuck of the surfacing equipment to the dried protective film that has previously been applied to the front surface of the lens. Alternatively, a wax or other hot melt adhesive of appropriate melting point (a temperature that will not damage the temporary film, the coating on the lens, the lens and any additives in those coatings or lens) may be used as the adhesive to hold the lens with the dried film to the chuck of the surfacing equipment. Yet another alternative that is used by some is to use a radiation curable urethane acrylate as a temporary adhesive. Any of these commonly employed means are suitable for use with the current invention. In all cases the dried film of the current invention both protects the lens and bonds to the lens with sufficient strength as to prevent slippage during processing.

The back side of the blocked lens can now be surfaced by cutting, grinding, fining, polishing, and otherwise processed by any means as well as equipment that are now commonly employed by those skilled in the art. Following surfacing, the lens is deblocked or separated from the chuck by impact or other means commonly used by those skilled in the art.

At this point, the protective film may be removed by washing, as may be necessary, such as if an antireflective coating or some other coating is later to be applied to the lens. To remove the film from the lens by washing, the lens is immersed for approximately 2 minutes in a bath containing a cleaning solution that has previously been prepared as described above, which cleaning solution is suitable for the rapid and complete dissolution or dispersion of the film but will not solvate or otherwise harm either the lens or the other coatings that may be applied to it. After removing the lens from the cleaning solution, the lens is rinsed in water, preferably purified water, such as deionized water. To facilitate the removal of the film in the bath, the bath may optionally be heated and may optionally employ ultrasonic energy of various frequencies. Such cleaning procedures are already a normal part of the cleaning processes that are used prior to the application of an antireflective coating and do not constitute additional cleaning steps. Many of the commercially available alkaline lens cleaners containing citrus oils or other terpenes are well suited as cleaning solutions for the purpose of removing the film from the lens. Many of these lens cleaners familiar to those skilled in the art for the purpose of washing fingerprints or other materials from lenses may be used for the purpose of removing the film from the lens. Different film compositions may require different cleaning solutions for the optimum rapid removal of the film. Alternatively, if no antireflective coating or no other coating is to be applied to the lens, the film may be left on the lens to protect the lens during subsequent processing and to provide a means of securing the chuck of the equipment to the lens.

Following the application of an antireflective coating, mirror coating, or some other coating to the surfaced lens, if one has been applied, the protective film may be reapplied as previously described. If the original protective film has not been removed and is still present, as indicated by the color, then the lens is already ready for the application of the adhesive pad, if desired, so that the lens can be secured to the chuck of the edging equipment and then edged.

Following edging, the adhesive pad is removed by manually peeling it off of the lens.

The film is then removed from the lens as previously described, resulting in a lens that is ready for placement in the spectacle frame of the wearer or some other device.

### EXAMPLES

The following are merely examples of the current invention and are not to be construed as limiting the invention in any way.

### Example 1

| Material | Weight Percent |
|---|---|
| 1-methoxy-2-propanol (Dow Chemical) | 74.89 |
| Masurf ® FS-2000 (Mason Chemical) | 0.10 |
| Joncryl ® 611 (BASF) | 5.00 |
| Navilan Green 9 (Morton International) | 0.01 |
| Total | 100.00 |

The above materials, at room temperature, are combined in the above listed order while mixing. The solution is mixed for four hours at room temperature to ensure complete dissolution of the acrylic polymer. The coating is then applied by spraying two milliliters onto the front surface of a semifinished polycarbonate lens blank as it spins at 1,000 rpm. After the coating has been applied, the lens is spun at 1,000 rpm for another 5 seconds, removing the excess coating to obtain the correct wet film thickness of approximately 6 microns. The wet film is then dried under an infrared lamp for five minutes to obtain a dry film thickness of approximately 2 microns prior to being blocked by using a metal alloy as a reusable adhesive to secure the chuck to the dried film that has been applied to the front surface of the semifinished lens blank. The lens is then surfaced and polished, after which the lens is deblocked in the manner that is commonly employed by those that are skilled in the art. The protective film is then removed by immersing the lens for 2 minutes in a cleaning solution of the following composition.

Cleaning Solution

| Material | Weight Percent |
|---|---|
| deionized water | 75.00 |
| orange oil | 20.00 |
| 2-propanol | 4.00 |
| potassium hydroxide | 1.00 |
| Total | 100.00 |

The lens is then rinsed in deionized water and is ready for subsequent processing as is normally employed by those skilled in the art. Upon inspection, the lens is found to have no defects, including such defects as would have been expected to occur if the lens had slipped during the edging process.

### Example 2

| Material | Weight Percent |
|---|---|
| 2-propanone (Dow Chemical) | 66.89 |
| Masurf ® FS-2000 (Mason Chemical) | 0.10 |
| Joncryl ® 6111 (BASF) | 33.00 |
| Morplas ® Red #49 (Morton International) | 0.01 |
| Total | 100.00 |

The above materials, at room temperature, are combined in the above listed order while mixing. The solution is mixed for one hour at room temperature to ensure complete dissolution of the acrylic polymer. The coating is then applied by spraying two milliliters onto the front surface of a semifinished polycarbonate lens blank as it spins at 1,000 rpm. After the coating has been applied, the lens having a superhydrophilic coating is spun at 1,000 rpm for another 5 seconds, removing the excess coating to obtain the correct wet film thickness of approximately 6 microns. The wet film is then dried at room temperature for 1 minute to obtain a dry film thickness of approximately 2 microns prior to the application of an adhesive pad to secure the chuck of the edging equipment to the lens. The lens is then edged to fit the frame, after which the adhesive pad is manually peeled off of the lens. The protective film is then removed by immersing the lens for approximately 2 minutes in an ultrasonic bath containing a cleaning solution of the composition that is described in Example 1 above. The lens is then rinsed in deionized water and is ready for subsequent processing as is normally employed by those skilled in the art. Upon inspection, the lens is found to have no defects, including such defects as would have occurred if the lens had slipped during the edging process.

What is claimed:

1. A method of temporarily protecting a lens before subsequent treatment of the lens comprising:
providing a polymeric ophthalmic lens having a front surface and a rear surface;
providing a coating solution comprising a water-soluble/dispersible or organic-soluble/dispersible organic polymer in a solvent, the solvent not attacking or dissolving the polymeric ophthalmic lens;
applying the coating solution to at least one of the front surface or the rear surface;
drying the coating solution on the lens to form a temporary protective coating;
supporting the lens;
modifying the lens; and
dissolving/dispersing the dried coating in a second solution without attacking, dissolving or damaging the lens.

2. The method of claim 1 wherein the modifying comprises abrading, grinding or removing material from the lens.

3. The method of claim 2 wherein the lens comprises a bisphenol A polycarbonate.

4. The method of claim 1 wherein the modifying comprises applying another coating to the lens onto a surface that does not carry the temporary protective coating;

5. The method of claim 4 wherein the modifying comprises removing material from edges of the lens.

6. The method of claim 1 wherein the coating solution is applied by spraying with an amount that coats the lens with 0.5-5 milliliters/lens of wet coating solution.

7. The method of claim 6 wherein the wet coating is air dried at ambient temperature.

8. The method of claim 6 wherein the wet coating is air dried at elevated temperatures.

9. The method of claim 6 wherein the wet coating is exposed to infrared radiation to dry the wet coating.

10. The method of claim 1 wherein the temporary protective coating contains a dye or pigment and after dissolving/dispersing the dried coating, the lens is examined for the presence of residual dye or pigment.

11. The method of claim 10 wherein the dye or pigment is luminescent or fluorescent.

12. The method of claim 1 wherein the temporary protective coating is placed at least on a front surface of the lens, a pad is placed over the temporary protective coating, and the lens with pad is clamped before modifying is begun, with a clamp in contact with the pad.

13. The method of claim 12 wherein after the clamp is released, the pad is stripped off the temporary protective coating and then the temporary protective coating is dissolved or dispersed.

14. The method of claim 1 wherein the temporary protective coating comprises an acrylate resin.

15. The method of claim 1 wherein the second solution is heated.

16. The method of claim 1 wherein the coating solution is applied by spraying with an amount that coats the lens with 2.0-5 milliliters/lens of wet coating solution.

17. The method of claim 1 wherein ultrasonic energy is used on the coating solution.
